(19) United States
(12) Patent Application Publication
(10) Pub. No.: US 2008/0274699 A1
(43) Pub. Date: Nov. 6, 2008

(54) Method for Analysing the Operation of a Radiocommunication Terminal, Corresponding Radiocommunication Terminal and Analysis Device

(76) Inventor: Jacques Montes, Le Perreux Sur Marne (FR)

Correspondence Address: WESTMAN CHAMPLIN & KELLY, P.A., SUITE 1400, 900 SECOND AVENUE SOUTH, MINNEAPOLIS, MN, 55402-3244, US

(21) Appl. No.: 10/577,338

(22) PCT Filed: Oct. 29, 2004
(86) PCT No.: PCT/FR04/02808

§ 371 Date: Jun. 9, 2008

(30) Foreign Application Priority Data
Oct. 31, 2003 (FR) 0312837

(51) Int. Cl. H04B 17/00

(52) U.S. Cl. 455/67.11

(57) ABSTRACT

A method and apparatus are provided for analyzing the operation of radiocommunication terminal according to a predetermined radiocommunication protocol. The radiocommunication terminal transmits data representing at least one operation to be analyzed to a remote analysis device via a link according to the predetermined radiocommunication protocol.

### CROSS-REFERENCE TO RELATED APPLICATION

This Application is a Section 371 National Stage Application of International Application No. PCT/FR2004/002806, filed Oct. 29, 2004 and published as WO 2005/043946 on May 12, 2005, not in English.

### FIELD OF THE DISCLOSURE

The disclosure relates to the field of supervising and analysis of the operation of radiocommunication devices, such as radiotelephones or terminals equipped with radiocommunication means (installed, for example, in machines, sensors, automobiles, and so on).

### BACKGROUND

In general, electronic products are tested in the most exhaustive manner possible, before they are placed on the market. However, the complexity of these apparatuses increases regularly, and it appears to be very difficult to test them integrally, and to identify all of the situations they may encounter.

This is due in particular to the fact that they have large and complex software means, and that they may encounter a wide variety of situations and applications.

This is the case in particular in the field of radiocommunications. The constructors of radiotelephony means and the operators are therefore constrained to distribute products that may still have certain software defects (or bugs) that have not been identified, for example because they correspond to circumstances that are very specific, very rare, or very difficult to anticipate and reproduce.

Such bugs may, for example, be associated with:
network characteristics (neighbouring cells, levels, etc.);
the SIM card (for example, number of SMS messages);
the hardware environment (battery level, peripheral elements, etc.)
user actions (navigation in menus, use of specific WAP, SMS, MMS, JAVA applications, and so on).

Although simulators and emulators are implemented so as to identify these bugs and remove them, there may still be situations in which the radiocommunication device does not react as it should. It is then necessary to study the operation of this device, so as to identify the origin of the bug, and, as appropriate, to make the necessary corrections.

To perform these operations, measuring and test apparatuses, such as protocol analysers, which are capable of observing and analysing the data exchanges carried out according to the protocols used by the radiocommunication device, are generally used.

This technique is effective, but often difficult to implement, since it requires the availability of complex equipment. When the defective apparatus is a radiotelephone, it is therefore necessary for the user to send it to a test laboratory, after having explained as precisely as possible the defect identified and the conditions under which it appears. It is a complicated approach, and deprives the user of his or her radiotelephone for several days or even several weeks. There is also a significant risk that the bug will not be identified, if the description of the problem is erroneous or incomplete.

When it involves radiotelephony means installed in machines, they must be disassembled so that they can be sent to a laboratory, or the test material must be used on site. Again, it is understood that, in both situations, this is complex and costly, with regard to both time and money.

### SUMMARY

An embodiment of the invention is directed to a method for analysing the operation of a radiocommunication terminal according to a predetermined radiocommunication protocol. According to an embodiment of the invention, said radiocommunication terminal transmits data representative of at least one operation to be analysed to a remote analysis device via a connection according to said predetermined radiocommunication protocol.

Thus, the analysis is not performed locally, using dedicated test apparatuses, which must be connected to the terminal, but remotely. The terminal itself internally performs the operations, and ensures the transmission of the data to be analysed to a remote supervisor.

The method of an embodiment of the invention advantageously includes a step involving the execution of a sequence of at least one operation, in said radiocommunication terminal, and temporary storage of data representative of said operation(s), preferably followed by a step involving the batch transmission of said data representative of said operation(s) to said remote analysis device.

According to an advantageous aspect of an embodiment of the invention, said steps of execution and transmission successively use the same radiocommunication protocol.

The approach of an embodiment of the invention is therefore to transmit the data to be analysed in batch mode. The terminal itself performs all of the test operations, then transmits the data resulting from the analysis (it is also possible to provide periodic transmissions, or at predetermined times, of these results, during the test).

Thus, it is possible to use the same connection (GSM, GPRS, etc.) for the test and its supervision. In addition, it is possible to use, on a remote site, powerful means, without it being necessary to physically work on the terminal.

The method of the invention preferably includes a previous step in which the radiocommunication terminal receives an analysis and/or analysis parameter scenario.

Said parameters may in particular include at least one of the following elements:
identification of at least one software element to be analysed;
identification of at least one data item to be transmitted;
identification of a sequence of at least one operation to be performed;
identification of an analysis level.

Said method also preferably includes a previous step in which said radiocommunication terminal receives data for configuration of the transmission to said remote analysis device.

Said configuration data may in particular include at least one of said following elements:
a telephone number corresponding to said remote analysis device;
parameters for configuration of the transmission of data to said remote analysis device.

According to an advantageous feature of an embodiment of the invention, the method implements an encryption for the transmission of data to and/or from said radiocommunication terminal.

In particular, it can use an encryption key for the transmission of said analysis and/or analysis parameter scenario.

An embodiment of the invention can also include a subsequent receptions step of reception by said radiocommunication terminal of updated data, according to the analysis of said data.

Said reception step(s) advantageously also use(s) said radiocommunication protocol.

According to an advantageous embodiment, said radiocommunication terminal implements an automated system, controlled by a scenario transmitted by said remote analysis device and/or stored in said radiocommunication terminal.

Said scenario can preferably perform at least one operation normally performed by a user of said radiocommunication terminal.

According to an advantageous feature, said radiocommunication terminal implements http commands, used to control analysis means.

An embodiment of the invention also relates to radiocommunication terminals including means for implementing the analysis method as described above, as well as corresponding analysis devices.

Other features and advantages will become more clear from the following description of a preferred embodiment of the invention, given by way of an illustrative and non-limiting example, and the appended drawings.

### BRIEF DESCRIPTION OF THE DRAWINGS

FIG. 1 diagrammatically shows the general principle of the invention; and

FIG. 2 is a simplified synoptic diagram of an embodiment of the method of the invention.

### DETAILED DESCRIPTION OF ILLUSTRATIVE EMBODIMENTS

An embodiment of the invention is therefore based on a new approach to the detection and analysis of problems (debugging) in the field of radiotelephony.

According to an embodiment of the invention, there is indeed no direct supervision, using a specific apparatus, on or by independent access, of RS232C type or the like, but a batch transmission of the information needed for the analysis, preferably using the protocol used for the communications themselves (for example, GSM, GPRS, 3GPP, and so on).

Thus, according to an embodiment of the invention, there is no need for special means within the vicinity of the terminal tested. It is the latter itself that performs the operations, and that stores the data needed for the analysis. It then transmits the data to a remote server, which will perform the analysis in batch mode, and, if appropriate, return the necessary corrections to the terminal.

Therefore, there is no complexity added at the level of the terminal (except in the case of software means), and it is possible to implement powerful analysis means remotely.

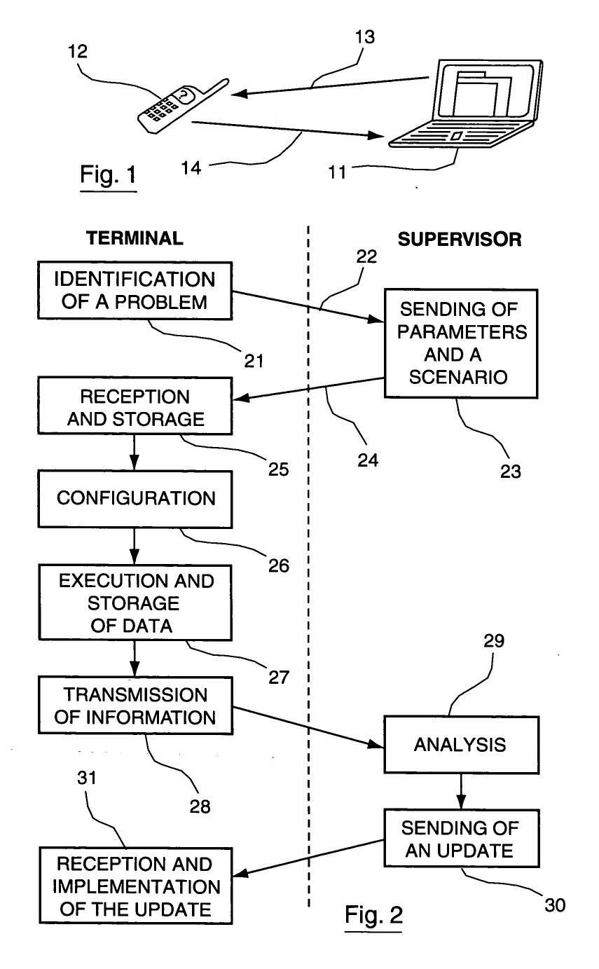

This approach is shown in particular in FIG. 1.

The supervising device 11 sends the terminal 12 debugging configuration data 13.

The terminal 12, which can be a radiotelephone, or radiotelephone means, such as a module, implanted in any type of machine, receives and processes the debugging data, which in particular include a sequence of operations to be performed.

When these operations have been performed, the terminal 12 sends debugging result data 14 to the supervising device 11. The latter then performs the corresponding analyses in batch mode.

This approach therefore makes it possible to perform debugging operations remotely, and therefore to analyse problems in the situation and in the environment in which the problem actually appears.

An interesting aspect of an embodiment of the invention is that it is possible to use the same (wireless) communication channel to:
configure the terminal for the debugging steps;
perform these steps; and
send the results to the supervisor.

An example of an embodiment is shown in FIG. 2.

The processing generally begins with the identification 21 of a problem in the terminal. The corresponding information for identifying a problem 22 is transmitted to the supervisor. This transmission can be performed automatically, using the radiocommunication network, or be requested independently, for example in the case of a voice telephone communication to an operator.

In other cases, this step can be suppressed, and the supervisor can decide to perform tests because said supervisor identified a problem, or simply by way of periodic verification.

Depending on the problem to be processed, the supervisor establishes and sends 23 a test scenario, as well as corresponding configuration parameters.

These parameters can in particular include the following elements:
information for connecting to the supervisor and transmitting the relevant data thereto:
   protocol stacks http, WSP, proprietary, and so on and “address” (for example, telephone number, URL, IP address, etc.);
   preferred transmission connections (data, GPRS, etc.) and strategy for use (for example, first GPRS, and otherwise SMS);
   test duration or debugging data transmission times (the duration can be, for example, one hour, one day or one week);
   security parameters (to avoid malicious uses):
      coding authorising the terminal to identify the supervisor, so as to obtain tested data;
      user interface enabling the user to accept or refuse a test sequence;
   data for managing the debugging trace:
      maximum size;
      circular buffer or not;
      . . .

The data 24 also includes a test scenario, describing all of the events and operations that the terminal must perform in order to produce the debugging data.

The scenario is advantageously an automated test system, implanted in the terminal.

It can define in particular:
events that will generate operations such as:
   events that will launch the test processes;
   network indications (registration, level, incoming communications, incoming SMS or MMS, and so on);
   timing expiration;
   indications concerning peripherals (USB access, battery levels, battery charge, and so on);
   interaction associated with the user (according to this aspect, the terminal can simulate actions performed by the user, such as a keyboard strike);
   . . .
operations, such as:
   telephone calls;
   SMS or MMS mailings;
   WAP access;
   network registrations;
   SIM card access;
   access to the terminal directory;
   Java applet application launchings;
   . . .

This data 24 is therefore received and stored 25 in the terminal. The latter, in view of the data received, configures 26 the test to be performed, then executes it and stores the corresponding test results 27.

The description of the scenario is advantageously presented in the form of an automated system, i.e. a series of events or actions and status changes. An example of an automated system capable of being used is described in patent document FR 0307992.

More generally, the language used for these scenarios can be a compiled or interpreted, proprietary or non-proprietary language.

Of course, the terminal must have memory zones dedicated to these operations, in order to store the test scenario and the corresponding parameters, and in order to store the corresponding results (debugging traces) produced by the execution of the tests.

The terminal must also have, in its on-board software, elements enabling the various operations associated with the debugging process to be implemented.

The terminal therefore carries out 27 various operations, simulating the usual operation, according to the instructions for the scenario received. The corresponding data, as defined in the test parameters, is stored internally.

When the test is terminated (either because the set time has passed or because the scenario defined has reached its end), all of the stored test data is transmitted 28 to the supervisor, which will be capable of analysing it 29 in batch mode.

Depending on this analysis, the supervisor will be able to determine the problem, and send the corresponding updated data 30, either autonomously, or from corrected data programmed by an operator.

This correction or updated data is received 31 in the terminal, which stores it in the locations provided therefor.

Thus, it is possible to easily and effectively perform debugging operations on a remote terminal, without it being necessary to connect test apparatuses thereto. The only communication means used are conventional radiotelephone communication means, available in the terminal (GSM, SMS, data, and so on). The terminal itself carries out the test sequence, then transmits the results for their analysis.

According to a specific embodiment, the terminal implements http commands so as to implement the operation of the automated system.

One or more embodiments of the invention thus provide a technique that does not require the defective device to be sent to a remote site, or a specialist to go on site with his test material.

In other words, an embodiment of the invention provides a technique enabling a bug to be analysed, and, if appropriate, the necessary repair operations to be performed remotely. It should be noted that the formulation of this problem, which is also contrary to the conventional practice of a person skilled in the art, is, per se, a part of an embodiment the invention.

An embodiment of the invention also provides such a technique that enables test, analysis and repair processing operations to be performed very rapidly, without the radiocommunication device being immobilised and unusable for long periods, greater than several hours or several days or weeks.

An embodiment of the invention also provides such a technique that does not require the user to provide a complex and complete description of the situation in which the identified problem occurs.

An embodiment of the invention also provides such a technique that does not require, in radiocommunication devices, complex, bulky and expensive technical means.

Although the present invention have been described with reference to preferred embodiments, workers skilled in the art will recognize that changes may be made in form and detail without departing from the spirit and scope of the invention.

1-16. (canceled)

17. A method for analysing the operation of a radiocommunication terminal according to a predetermined radiocommunication protocol, the method comprising the following steps:
receiving by said radiocommunication terminal an analysis scenario and/or analysis parameter; and
transmitting from said radiocommunication terminal data representative of at least one operation to be analysed to a remote analysis device, via a connection according to said predetermined radiocommunication protocol, subsequent to said step of receiving.

18. The method according to claim 17 and further comprising a step involving the execution of a sequence of at least one operation, in said radiocommunication terminal, and temporary storage of said data representative of said operation(s), and wherein the step of transmitting comprises a step of batch transmission of said data representative of said operation(s), to said remote analysis device.

19. The method according to claim 18, wherein said execution and transmission steps successively use the same radiocommunication protocol.

20. The method according to claim 17, wherein said analysis parameter includes at least one of the following elements:
identification of at least one software element to be analysed;
identification of at least one data item to be transmitted;
identification of a sequence of at least one operation to be performed;
indication of an analysis level.

21. The method according to claim 17, wherein the method further includes a step, previous to the step of transmitting, in which said radiocommunication terminal receives data for configuring the transmission to said remote analysis device.

22. The method according to claim 21, wherein said configuration data includes at least one of said following elements:
a telephone number corresponding to said remote analysis device; and
parameters for configuration of the transmission of data to said remote analysis device.

23. The method according to claim 17, wherein the method implements an encryption for the transmission of data to and/or from said radiocommunication terminal.

24. The method according to claim 17, wherein the method uses an encryption key for the transmission of said analysis scenario and/or said analysis parameters.

25. The method according to claim 17 and further comprising a subsequent step in which said radiocommunication terminal receives updated data from the remote analysis device, based on the analysis of said data.

26. The method according to claim 17, wherein said step of receiving also uses said radiocommunication protocol.

27. The method according to claim 17, wherein said radiocommunication terminal implements an automated system, controlled by the analysis scenario transmitted by said remote analysis device and/or an analysis scenario stored in said radiocommunication terminal.

28. The method according to claim 27, wherein said scenario ensures that at least one operation normally performed by a user of said radiocommunication terminal is performed.

29. The method according to claim 17, wherein said radiocommunication terminal implements http commands, used to control the remote analysis device.

30. A radiocommunication terminal comprising:
means for receiving an analysis scenario and/or analysis parameter; and
means for transmitting data representative of at least one operation to be analysed to a remote analysis device, via a connection according to a predetermined radiocommunication protocol, subsequent to said step of receiving.

31. A remote analysis device comprising:
means for transmitting an analysis scenario and/or analysis parameter to a radiocommunication terminal; and
means for receiving from said radiocommunication terminal data representative of at least one operation to be analysed, via a connection according to a predetermined radiocommunication protocol, subsequent to said step of transmitting.
